(19) United States
(12) Patent Application Publication
(10) Pub. No.: US 2011/0101946 A1
(43) Pub. Date: May 5, 2011

(54) VOLTAGE CONVERTERS

(76) Inventor: James Hung Nguyen, San Jose, CA (US)

(21) Appl. No.: 13/001,364

(22) PCT Filed: Jun. 30, 2009
(86) PCT No.: PCT/US09/49281

§ 371 Date: Dec. 23, 2010

Related U.S. Application Data
(60) Provisional application No. 61/077,121, filed on Jun. 30, 2008.

(51) Int. Cl. H02M 3/155

(52) U.S. Cl. 323/282

(57) ABSTRACT

Various aspects can be implemented to achieve efficient voltage conversion. In general, one aspect can be a switching regulator for DC-DC step-down voltage conversion that includes a high-side transistor and a low-side transistor coupled in series and a first circuitry configured to operate in a synchronous mode such that the high-side transistor and the low-side transistor are used for voltage switching. The switching regulator also includes a second circuitry configured to operate in a non-synchronous mode such that the high-side transistor and one or more diodes are used for voltage switching. The switching regulator further includes an automatic mode selector configured to output a control signal and automatically select between the synchronous mode of operation and the non-synchronous mode synchronous mode of operation based in part on a voltage between source and drain of the low-side transistor and a predetermined delay time.

### TECHNICAL FIELD

This disclosure generally relates to voltage converters, in particular, DC to DC voltage converters.

### BACKGROUND

Voltage converters can be used to provide a predetermined and constant output voltage to a load from an arbitrary input voltage source. The input voltage source can be a higher or a lower voltage than the output voltage. Switching regulators can be an efficient way of achieving voltage conversion. The switching regulator employs a switch (e.g., a power transistor) coupled either in series or parallel with the load. The regulator controls the turning on and turning off of the switch in order to regulate the flow of power to the load. The switching regulator employs inductive energy storage elements to convert the switched current pulses into a steady load current. Thus, power in a switching regulator is transmitted across the switch in discrete current pulses.

Because of their increased efficiency, switching regulators are typically employed in battery-operated systems such as portable and laptop computers and hand-held devices. In such systems, when the switching regulator is supplying close to the rated output current (e.g., when a disk or hard drive is ON in a portable or laptop computer), the efficiency of the overall circuit can be high. However, the efficiency is generally a function of output current and typically decreases at low output current. This reduction in efficiency is generally attributable to the losses associated with operating the switching regulator. These losses include, among others, quiescent current losses in the control circuitry of the regulator, switching losses, switch driver current losses and inductor/transformer winding and core losses.

### SUMMARY

This specification describes various aspects relating to voltage converters that can maintain high efficiency at various output current levels. For example, a dual-mode converter design can be used to implement the voltage conversion and such design can automatically select between a synchronous operation mode and a non-synchronous operation mode depending on certain predefined conditions. Further, a minimum on-time feature can be implemented at low output current levels to increase efficiency by forcing the high-side transistor to stay on for a minimum time period and skip switching cycles. Such minimum on-time duration can be externally programmable by a user. In this manner, certain losses (e.g., switching losses) can be minimized and the converter efficiency can be maintained even at low output current levels.

In general, one aspect can be a switching regulator for DC-DC step-down voltage conversion that includes a high-side transistor and a low-side transistor coupled in series and a first circuitry configured to operate in a synchronous mode wherein the high-side transistor and the low-side transistor are used for voltage switching and to provide a regulated output voltage to a load. The switching regulator also includes a second circuitry configured to operate in a non-synchronous mode wherein the low-side transistor remains off and further wherein the high-side transistor and one or more diodes are used for voltage switching and to provide a regulated output voltage to the load. The switching regulator further includes an automatic mode selector configured to output a control signal and automatically select between the synchronous mode of operation and the non-synchronous mode of operation based in part on a voltage between source and drain of the low-side transistor and a predetermined delay time. Other implementations of this aspect include corresponding methods, circuits, and systems.

Another general aspect can be a method of operating a switching regulator for DC-DC step-down voltage conversion, the method includes automatically determining whether the switching regulator should be operating in a synchronous mode wherein a high-side transistor and a low-side transistor are used for voltage switching or in a non-synchronous mode wherein a high-side transistor and one or more diodes are used for voltage switching, based in part on whether a control signal produced by an automatic mode selector is logically low or logically high. The method also includes operating the switching regulator in a synchronous mode if the control signal is logically low. The method further includes operating the switching regulator in a non-synchronous mode if the control signal is logically high, wherein the low-side transistor remains off during the entire non-synchronous mode.

Yet another general aspect can be a switching regulator for DC-DC step-down voltage conversion that includes a high-side transistor and a low-side transistor coupled in series and a first circuitry configured to operate in a synchronous mode wherein the high-side transistor and the low-side transistor are used for voltage switching and to provide a regulated output voltage to a load. The switching regulator also includes a second circuitry configured to operate in a non-synchronous mode wherein the low-side transistor remains off and further wherein the high-side transistor and one or more diodes are used for voltage switching and to provide a regulated output voltage to the load. The switching regulator further includes means for automatically selecting between the synchronous mode and the non-synchronous mode.

These and other general aspects can optionally include one or more of the following specific aspects. The automatic mode selector can automatically select the non-synchronous mode of operation when the following conditions are met during the predetermined delay time: the voltage between source and drain of the low-side transistor is greater than zero; a pulse-width modulation (PWM) signal is logically low; and a clock signal pulse is on a falling edge. The automatic mode selector can automatically select the synchronous mode of operation when the following conditions are met during the predetermined delay time: a voltage across the one or more diodes is less than zero; the pulse-width modulation (PWM) signal is logically low; and the clock signal pulse is on a falling edge. The predetermined delay time can be a consecutive number of clock cycles or a fixed period of time, e.g., 20 microseconds.

The non-synchronous mode of operation can include a minimum on-time circuitry configured to keep the high-side transistor on for a period of time greater or equal to a predetermined minimum on-time duration. The minimum on-time circuitry can be configured such that the switching regulator operates in a pulse skipping mode wherein the switching frequency is reduced. For example, the high-side transistor can be forced to stay on for a period of time greater or equal to a predetermined minimum on-time duration. The minimum on-time duration can be programmed by a user; e.g., by adjusting the resistor value connected to a feed forward (RFF) pin of the voltage converter circuit.

The non-synchronous mode of operation can include three operational states: a first state during which the high-side transistor is on and the one or more diodes are off; a second state during which the high-side transistor is off and the one or more diodes are on, wherein the switching regulator changes from the first state to the second state only if the PWM signal is logical high and an on-time of the high-side transistor is greater than or equal to a minimum on-time duration; and a third state during which the high-side transistor is off and the one or more diodes are off. The control signal can be logically low when the switching regulator is operating in the synchronous mode and logically high when the switching regulator is operating in the non-synchronous mode. The one or more diodes can include either a body diode of the low-side transistor or a Schottky diode, or both. The switching regulator can also include means for increasing efficiency at low output current levels when the switching regulator is operating in the non-synchronous mode.

Particular aspects can be implemented to realize one or more of the following potential advantages. The circuits and methods described herein can achieve an integrated circuit with automatic selection of mode operation between a synchronous mode and a non-synchronous mode. Thus, pin count can be reduced and less signal trace is required on the board because additionally controller signals can be avoided. Moreover, a minimum on-time feature can be implemented to reduce switching losses at low output current levels. Therefore, the circuits and methods described herein can maximize the voltage converter efficiency at various output levels.

The general and specific aspects can be implemented using a circuit, a method, a system, or any combination of circuits, systems and methods. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is an operational flow diagram of a dual-mode buck converter with automatic synchronous/non-synchronous mode selection.

FIG. 2 is a schematic block diagram of an example dual-mode buck converter.

FIG. 3 is a series of simulated waveforms for the synchronous mode operation of an example dual-mode buck converter.

FIGS. 4A-4C are a series of simulated waveforms showing the minimum on-time feature and the pulse skipping mode operation of an example dual-mode buck converter.

FIG. 5 is an example application circuit for a dual-mode buck converter.

FIG. 6 is another example application circuit for a dual-mode buck converter.

Like reference symbols in the various drawings indicate like elements.

### DETAILED DESCRIPTION

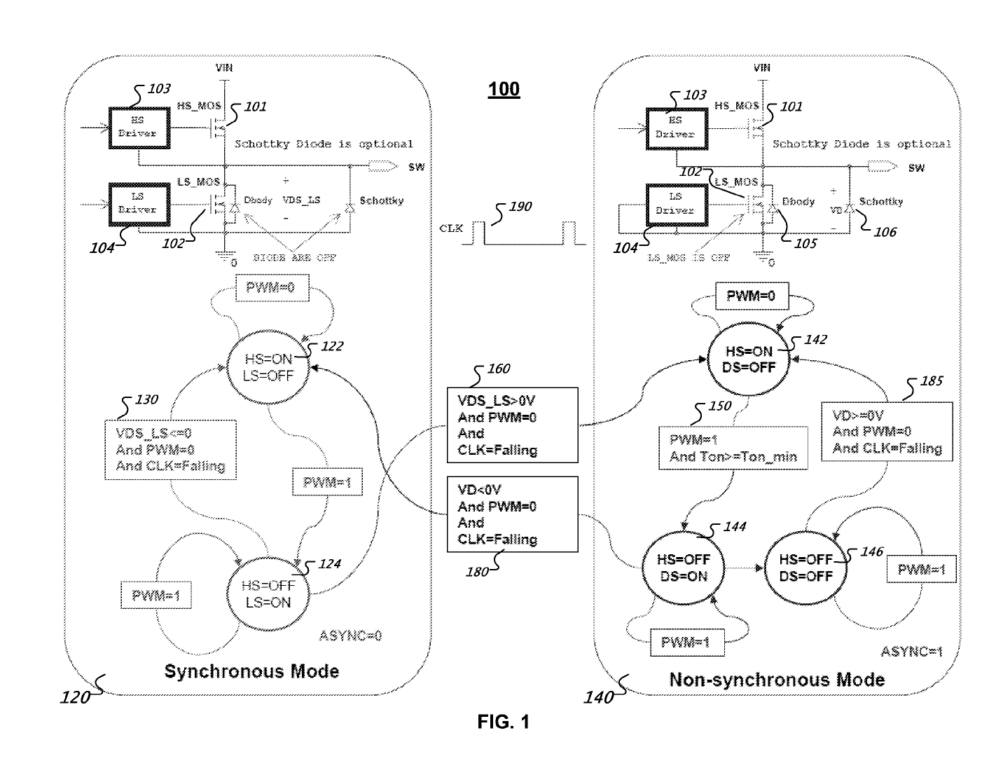

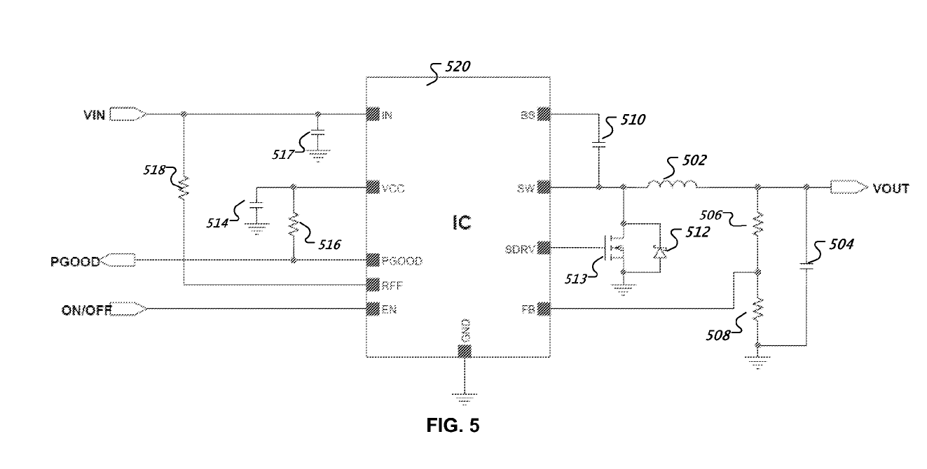

FIG. 1 is an operational flow chart of an example dual-mode buck converter integrated circuit 100, which can automatically select between a synchronous operation mode 120 and a non-synchronous operation mode 140 depending on certain predefined conditions. A buck converter is a step-down DC to DC voltage converter. A synchronous buck converter is a modified version of the basic buck converter circuit topology in which two transistors (instead of a transistor and a diode) are used as switches. As shown in FIG. 1, the input voltage (V_{IN}) is converted to an output voltage at terminal SW of the circuit 100 based on the switching duty cycle of the switches. A typical application circuit that includes an inductor and a capacitor connected to the output or the load will be described in more detail in FIG. 5 below.

During the synchronous mode operation 120, two transistors are used for the switching elements. Under certain load conditions, it may be more efficient to operate the converter circuit 100 in a non-synchronous mode 140, where only one transistor is used for voltage conversion. In one implementation, the non-synchronous operation mode 140 is selected when the voltage across the source and drain of the lower transistor is greater than zero (V_{DS}_{_{—}}_{LS}>0), while the “PWM” signal is low and the clock pulse (“CLK”) is on the falling (negative) edge. These predefined conditions are shown in box 160 of FIG. 1. As will be discussed in more detail below, the non-synchronous operation mode 140 can be used to improve efficiency at low output current levels.

Synchronous Mode

As shown in FIG. 1, the synchronous operation mode 120 uses two switching transistors, a high-side transistor (HS_MOS) 101 that serves as the main switch and a low-side transistor (LS_MOS) 102 that serves as a synchronous switch, to step down the input voltage (Vᵢₙ) to a lower output voltage (Vₒᵤₜ). In one implementation, HS_MOS 101 and LS_MOS 102 are both N-MOSFET devices. In other implementations, HS_MOS 101 can be P-MOSFET. Each of the switching transistors 101 and 102 is enabled or disabled respectively by a gate driver. For example, the HS_MOS 101 has a high-side gate driver (HS Driver) 103 and the LS_MOS 102 has a low-side gate driver (LS Driver) 104. Control signals are delivered to the HS Driver 103 and the LS Driver 104 to enable and disable the transistors. When the switching transistor is in the ON state, it acts like an electrical short, with very little electrical resistance (R_{DS,ON}). On the other hand, when the transistor is in the OFF state, it acts like an electrical open and no current passes through it.

Referring to FIG. 1, the operational flow chart for the synchronous mode 120 shows two operational states: an “ON” state 122, which corresponds to the HS transistor 101 being turned on while the LS transistor 102 is off (HS=On and LS=Off); and an “OFF” state 124, which corresponds to the HS transistor 101 being off while the LS transistor 102 is turned on (HS=Off and LS=On). In addition, the dual-mode converter of FIG. 1 has a system clock running at a fixed frequency, denoted as CLK pulses 190.

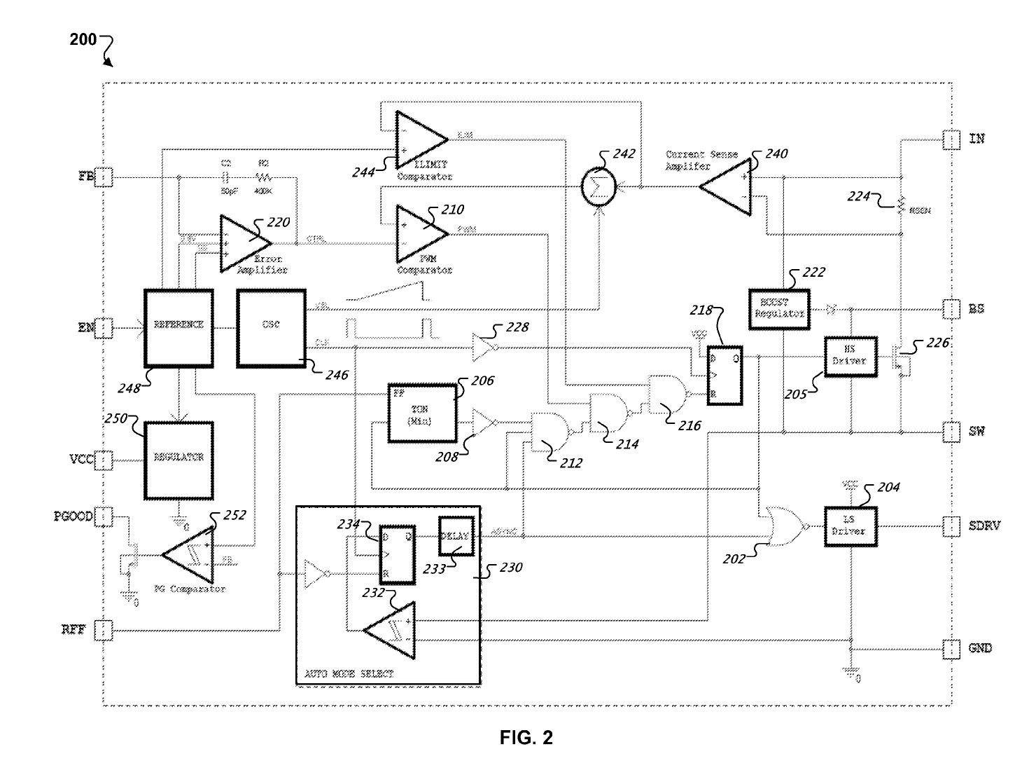

As an example, suppose that the operational state of the converter circuit 100 is initially in the “OFF” state 124. The flow chart of FIG. 1 indicates that the “OFF” state will be maintained as long as the pulse-width-modulation (PWM) signal is high (denoted as PWM=1). This PWM signal is produced by the PWM Comparator 210, shown in the schematic block diagram of FIG. 2, and is the control signal applied to the logic circuitry (e.g., NAND gates and a flip-flop) in order to toggle on/off the HS and LS transistors (101 and 102). Referring back to the operational flowchart of FIG. 1, the “OFF” state 124 will be changed to the “ON” state 122 when the voltage across the drain and source terminals of the LS transistor 102 is less than or equal to zero (V_{DS}_{_{—}}_{LS}≦0), while the PWM signal is low (PWM=0) and the clock signal 103 is on the falling edge (CLK=Falling). These predefined conditions are shown in box 130.

Once the circuit 100 enters the “ON” state 122, it will remain in that state for as long as the PWM signal is low (PWM=0). If the “PWM” signal turns high (PWM=1), however, the circuit 100 returns back to the “OFF” state 124 again, with HS transistor 101 being OFF and LS transistor 102 being ON. In this manner, in the synchronous mode 120, the HS transistor 101 and LS transistor 102 operate out-of-phase (i.e., when one transistor is ON the other transistor is OFF). Moreover, there is typically a certain amount of dead time (e.g., 5-10 nanoseconds) designed between the transition of one transistor being ON and the other transistor being OFF in order to avoid a condition where both transistors are ON at the same time.

During the “OFF” state 124 in the synchronous mode 120 the circuit can automatically enter into the non-synchronous mode 140 when certain predefined conditions are met. In one example as shown in FIG. 1, the switching from the synchronous mode 120 to the non-synchronous mode 140 occurs when the voltage across the drain and source terminals of the LS transistor 102 is greater than zero (V_{DS}_{_{—}}_{LS}>0), while the PWM signal is low (PWM=0) and the clock signal is on the falling edge (CLK=Falling). These predefined conditions are shown in box 160. Recall also that during the “OFF” state 124 of the synchronous mode operation 120 if V_{DS}_{_{—}}_{LS}≦0 (voltage across the drain and source terminals of the LS transistor is less than or equal to zero), while the PWM signal is low (PWM=0) and CLK signal is on the falling edge, the circuit 100 simply switches to the “ON” state 122 and remains in the synchronous mode 120. Therefore, when the circuit 100 is in the OFF state 124 of the synchronous mode operation 120, the condition of V_{DS}_{_{—}}_{LS} (i.e., >0 or 0) determines whether the circuit switches from the OFF state 124 to the ON state 122 (while remaining in the synchronous mode 120) or from the OFF state 124 to non-synchronous mode 140.

Non-synchronous Mode

Once the circuit enters the non-synchronous operation mode 140, the LS transistor 102 remains OFF throughout the entire duration of the non-synchronous operation mode. In this manner, the voltage conversion in the non-synchronous operation mode 140 is performed by the HS transistor 101 and a diode, instead of a pair of transistors 101 and 102. This diode can be the body diode (D_{body}) 105 of the LS transistor 102 or a separate Schottky diode (Schottky) 106 in parallel with the body diode 105. Using the Schottky diode 105 can be more efficient than just using the body diode 105 because the voltage drop across the Schottky diode 106 is lower than the body diode 104. In addition, the Schottky diode 106 can either be integrated with the buck converter integrated circuit 100 or as an external component.

As shown, the operational flow chart for the non-synchronous mode 140 includes three operational states: an “ON” state 142, which corresponds to the HS transistor 101 being turned on while the diode 105 and/or 106 is off (HS=On and DS=Off); an “OFF” state 144, which corresponds to the HS transistor 101 being off while the diode 105 and/or 106 is turned on (HS=Off and DS=On); and a “Standby” state 146, which corresponds to the HS transistor 101 and the diode 105 and/or 106 being turned off. During the non-synchronous operation mode 140, the LS transistor 102 is maintained OFF by a control signal (the “Async” signal). For example, when the Async signal is logical high, the LS transistor 102 is kept OFF and the circuit remains in the non-synchronous operation mode 140. Detailed operation of the Async signal will be described further below.

Furthermore, once the circuit enters the non-synchronous operation mode 140, the HS transistor 101 turns ON and the diode 105 and/or 106 is OFF because the diode is in reverse bias. This is an “ON” state 142 during the non-synchronous operation mode 140. As noted above, the LS transistor 102 is OFF because the “Async” signal remains high throughout the non-synchronous operation mode 140. Once the PWM signal goes high (PWM=1) and T_{ON}>T_{ON}_{_{—}}_{Min} (where T_{ON} is the duration that HS transistor 101 is ON and T_{ON}_{_{—}}_{Min} is a pre-established minimum on-time) the HS transistor turns OFF and the diode is in forward bias. These predefined conditions are shown in box 150. This is an “OFF” state 144 during the non-synchronous operation mode 140. Further, from this OFF state 144 there can be two possible subsequent circuit operations: the first is switching back to the synchronous mode 120; the second is entering a Standby state 146 where HS transistor 101 is OFF, LS transistor 102 is OFF, and the diode is OFF.

As shown in FIG. 1, the circuit can automatically switch back to the synchronous operation mode 120 when V_{D}<0 (voltage across the diode is negative, which indicates that the diode is forward biased), while the PWM signal turns low (PWM=0) and CLK signal is on the falling edge (CLK=Falling). These predefined conditions are shown in box 180. On the other hand, if PWM signal remains high (PWM=1) and the inductor current approaches zero or V_{D}≧0 (voltage across the diode is zero or positive, which indicates that the diode is no longer forward biased), then the circuit enters the Standby state 146 where both the high side transistor 101 and the diode 105 and/or 106 are OFF. During the Standby state 146, the output circuit becomes decoupled from the ground and prevents a polarity reversal condition, where the inductor starts to draw power from the load. From this Standby state 146, the HS transistor 101 turns ON and circuit 100 returns back to the “On” state 142 once the PWM signal turns low (PWM=0), while V_{D}≧0 and CLK signal is on the falling edge (CLK=Falling). These predefined conditions are shown in box 185.

In this manner, the operational flow diagram of FIG. 1 illustrates a dual-mode converter design that can be used to implement the voltage conversion and such design can automatically select between a synchronous operation mode and a non-synchronous operation mode depending on certain predefined conditions. Further, a minimum on-time feature can be implemented at low output current levels to increase efficiency by forcing the high-side transistor to stay on for a minimum time period and skip switching cycles. Such minimum on-time duration can be externally programmable by a user. Thus, certain losses (e.g., switching losses) can be minimized and the converter efficiency can be maintained even at low output current levels.

FIG. 2 is a schematic block diagram of an example dual-mode buck converter integrated circuit 200. As shown, the circuit 200 has 10 pins: there is a feedback pin (FB) for monitoring the output voltage, an enable pin (EN) for turning on/off the circuit operation, input voltage pin (IN), a bias pin for internal voltage supply (VCC), a power good pin (PGood) that denotes power supply is OK; a feed forward pin (RFF) for adjusting the minimum on-time duration, a bootstrap pin (BS) for biasing the high-side gate driver, an output pin (SW), a gate driver pin (SDRV) to drive an external low side NMOS, and a ground pin (GND).

As noted above, the LS transistor is OFF throughout the entire non-synchronous operation mode because the Async signal remains high. As shown in FIG. 2, the Async signal is the output of the “Auto Mode Select” circuit 230, which is an automatic mode selector circuit that includes a comparator 232, a delay circuit 233, and a flip-flop 234. The delay circuit 233 can be used to prevent the dual-mode converter circuit from switching back and forth between the synchronous mode and the non-synchronous mode. Further, delay circuit 233 can be used to implement a predetermined delay time so that the circuit stays in the existing mode before switching to another mode of operation. For example, when the circuit is operating in the synchronous mode and if the predefined conditions (box 160 of FIG. 1) are met for the predetermined delay time (e.g., a number of consecutive cycles) then it switches to the non-synchronous mode. The predetermined delay time can be a couple of the clock cycles (e.g., 2 or 3 clock cycles), or some other predetermined amount of time (e.g., 20 μs).

As shown, the Async signal is applied to a NOR gate 202, which in turn connects to the LS Driver 204 (which is the gate driver for LS transistor). Therefore, when the Async signal is logically high (Async=1), one of the inputs to the NOR gate 202 is high, and the output of the NOR gate 202 will be low regardless of the state of the other input (this is because the only way for the output of the NOR gate 202 to be high is when both inputs are low). In this manner, as long as the Async signal is logical high, the LS transistor will remain OFF because the input to the LS Driver 204 remains low.

Also noted above is that the PWM signal is a control signal that controls whether the buck converter circuit operates in an “ON” state (HS transistor is on) or an “OFF” state (HS transistor is off). This PWM signal is produced by the PWM Comparator 210 and is the control signal applied to the logic circuitry (e.g., NAND gates 214, 216 and a flip-flop 218) in order to toggle on/off the HS transistor gate driver 205 and the LS transistor gate driver 204. Further, FIG. 2 shows the oscillator (OSC) 246, current sense amplifier 240, PWM comparator 210 and the error amplifier 220 are used to operate dual-mode buck converter integrated circuit 200 in a fixed frequency, peak current control mode to maintain a regulated output voltage. For example, when a PWM cycle is initiated by the negative edge (falling edge) of CLK signal, the HS transistor 226 turns on and remains on until its current reaches the value set by the error amplifier 220 output (CTRL signal). When HS transistor 226 is off, it remains off until the next clock cycle starts. The error amplifier 220 compares the FB pin voltage with the internal reference (e.g., 0.8V) and outputs a current proportional to the difference between the two values. This output current from error amplifier 220 is used to charge or discharge the internal compensation network (R2 and C2) to form a voltage signal (CTRL signal), which is used to control the HS transistor 226 current. The HS transistor 226 current is converted to a voltage by a resistor RSEN 224 and current sense amplifier 240. Furthermore, this voltage is added with slope compensation (VSL signal) and then compared to error amplifier output voltage signal (CTRL signal) by PWM comparator 210. In this manner, the output of PWM comparator 210 (PWM signal) modulates the duty cycle to regulate the out put voltage (VOUT).

In addition, FIG. 2. shows a minimum on-time circuit 206, which includes a feed forward input (FF) from the RFF pin. In one implementation, this feed forward can be connected to a resistor external to the input voltage of buck converter (Vᵢₙ). This way, a user can adjust the duration of the minimum on-time via this external resistor. The output of the minimum on-time circuit 206 is connected to a NOT logic gate 208, which is in turn connected to the NAND gate 212. Thus, when the output of the minimum on-time circuit 206 is low, the output through the NOT gate 208 becomes logical high. When ASYNC and the Q output of the flip-flop (DFF) 218 are already high during the ON cycle of the non-synchronous mode, the output of NAND gate 212 is low because the output of the minimum on-time circuit 206 is also high. This logical low from NAND gate 212 prevents the PWM signal (from PWM comparator 210) from resetting the DFF 218. Thus, even though PWM signal goes high the “ON” state (i.e., HS transistor is ON and the DS is OFF) is not terminated until the output of the minimum on-time circuit 206 is also high. These predefined conditions are shown as box 150 in FIG. 1. Therefore the ON cycle is greater or equal to the minimum on-time.

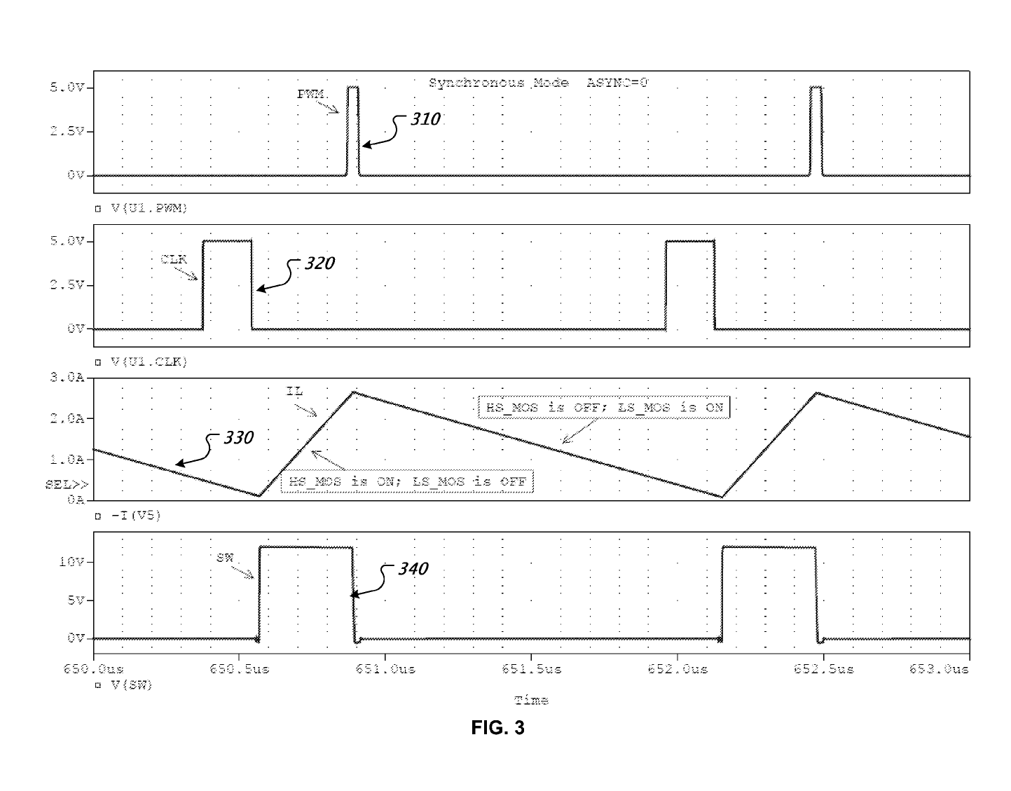

FIG. 3 shows a series of simulated waveforms for the synchronous operation mode of a dual-mode buck converter circuit. As noted above, during the synchronous operation mode, the control signal (Async) for synchronous/non-synchronous operation stays logical low (Async=0). These simulated waveforms include a PWM waveform 310, which illustrates logical high and low of the PWM signal, and a clock waveform 312 (CLK), which corresponds to the pulse train for the clock pulse and shows the rising edge and the falling edge of the CLK signal. There is a current waveform 330 (I_{L}) that corresponds to the current through the output inductor during both “ON” and “OFF” states of the synchronous operation mode. There is also a switching voltage waveform 340 (SW), which corresponds to the voltage transferred from Vᵢₙ to Vₒᵤₜ. In addition, these waveforms 310, 320, 330, and 340 are shown with the same time scale (x-axis), and are aligned vertically. For example, the graphs show that at the falling edge of the CLK pulse 320, when PWM pulse 310 is low, the HS transistor is ON and the LS transistor is OFF.

Further, during this “ON” state (i.e., HS transistor is ON and the LS transistor is OFF), the inductor current 330 starts to ramp up because the inductor is being charged by the input voltage (Vᵢₙ). Additionally, the switching voltage 340 during the “ON” state is approximately equal to Vᵢₙ, which is about 12 volts in this example. On the other hand, when the PWM pulse 310 turns high (˜5V), the HS transistor is OFF and the LS transistor is ON, and the circuit is in the “OFF” state. During the “OFF” state, the inductor current 330 starts to ramp down linearly at a slope proportional to the voltage across the inductor. In addition, during the “OFF” state, the switching voltage 340 is approximately below zero at a voltage level that equals to the LS transistor on resistance times the inductor current.

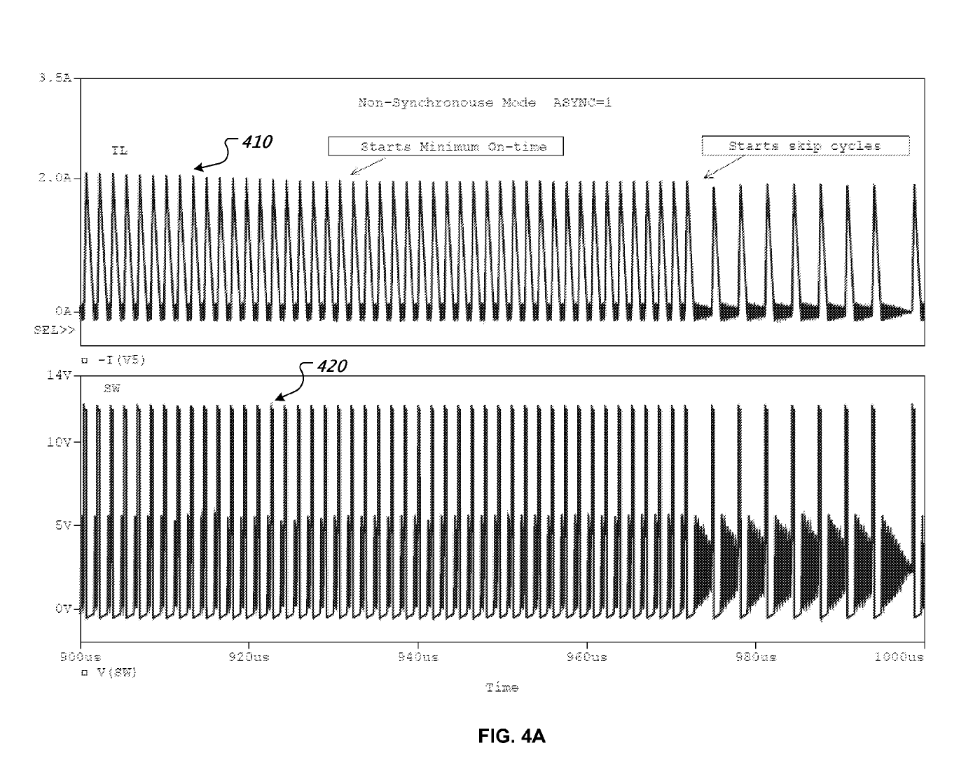

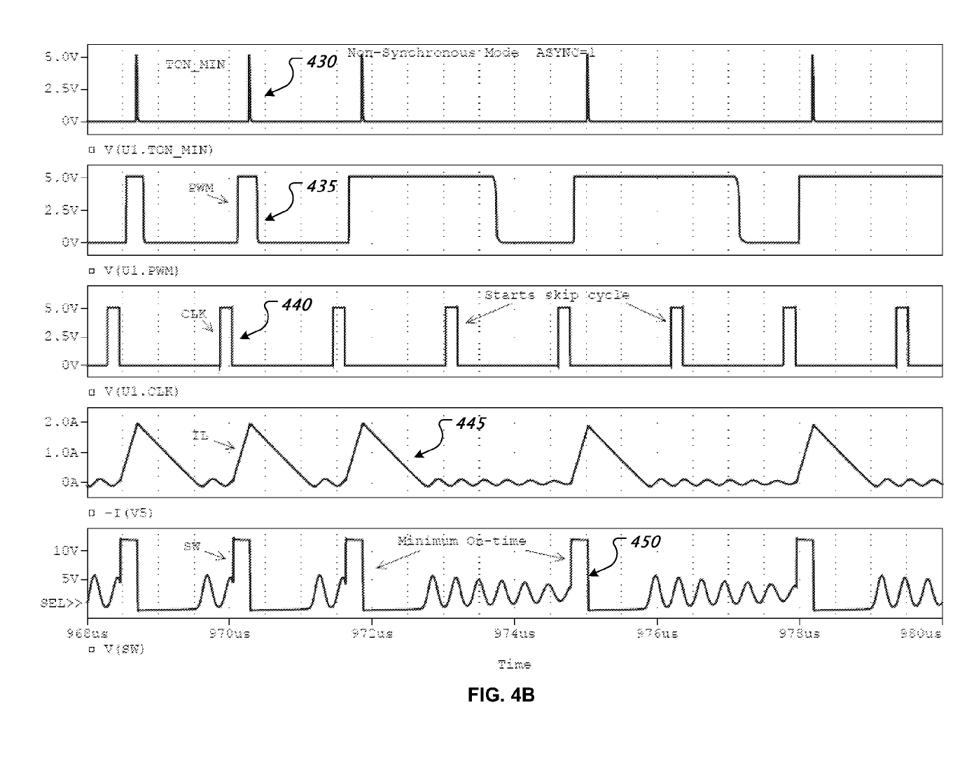

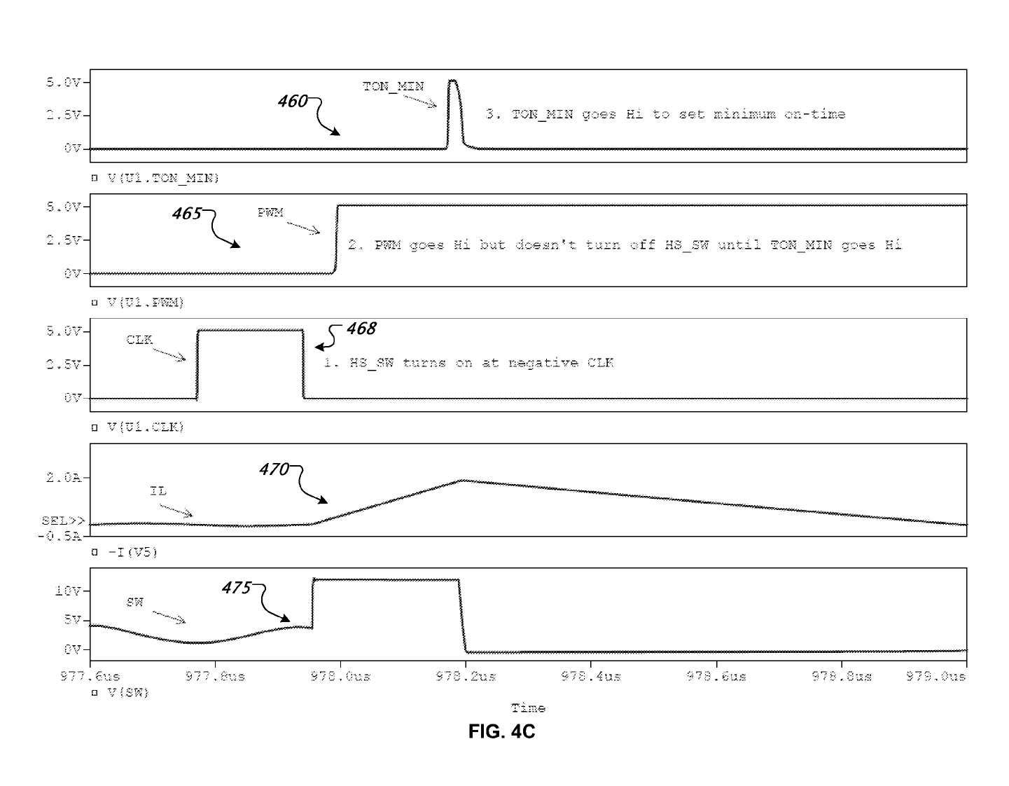

FIGS. 4A-4C are a series of simulated waveforms showing the minimum on-time feature and the pulse skipping mode operation of an example dual-mode buck converter. As noted above, during the non-synchronous operation mode, the minimum on-time feature can be used to increase efficiency of the voltage converter during low output currents by forcing the HS transistor to stay on for a minimum time period and skip some switching cycles. This is because at low output current conditions, the efficiency can be increased by reducing the switching loss of the HS transistor; thus, by forcing the HS transistor to stay on for a minimum amount of time (similar to a constant-on condition), the amount of switching loss is minimized. In order to maintain the same output voltage, however, the switching frequency will have to be reduced. That is, the HS transistor need not be turned on as frequently as indicated by the PWM pulse train and the circuit will operate in a pulse skipping mode, where the HS transistor does not turn on/off at the same frequency as the PWM pulse.

As shown in FIG. 4A, the peak inductor current IL 410 becomes smaller when output load current is reduced. As output load current continues to decrease, peak inductor current 410 remains constant after the minimum on-time feature is initiated. Moreover, if output load current continues to reduce, the circuit will start to skip cycles (pulse skipping mode), and the switching frequency is reduced. In one implementation, the minimum on-time duration can be externally programmable by a user via a resistor (e.g., 500 kohms), which can be connected from RFF pin (as shown in FIG. 5 below) to Vᵢₙ. In this manner, the resistor can provide a feed forward capability such that when Vᵢₙ increases, the minimum on-time reduces. Further, a larger resistor value will make the cycle enter the pulse skipping mode at an earlier time (or at higher output load current). The feed forward resistor can also be integrated to reduce pin count but the user will lose the option to program the minimum on-time duration. Additionally, the switching voltage waveform 420 (SW) of FIG. 4A shows that as the output current reduces, the switching frequency is reduced (i.e., the spacing between SW waveform peaks increases).

As shown in FIG. 4B, during the non-synchronous mode operation (Async=1), when the load becomes small the converter enters a discontinuous conduction mode, which means that the inductor current IL 445 becomes zero and SW 450 become high impedance (shown as ringing) during the OFF cycle. Once the minimum on-time feature is implemented, a minimum duty cycle is imposed on the switching transistor, and the peak inductor current 445 stays constant during every ON cycle. Thus, the same amount of energy is transferred to output at every cycle. If output load continues to reduce then converter needs to reduce the on cycle to lower the peak current IL 445. Since the buck converter cannot reduce the ON cycle (because HS transistor stays on for a minimum on-time), it skips cycles (pulse skipping mode) to maintain the output voltage as output load decreases. FIG. 4B also shows that the SW 450 does not turn on at the 4^{th}, 6^{th} and 8^{th} pulses of the negative edge of CLK 440. Further, in certain implementations, the converter can skip more than one cycle as needed to maintain the output voltage.

The waveforms shown in FIG. 4C further illustrate how the minimum on-time feature can be implemented. For example SW 475 goes high and current IL 470 ramps up at falling (negative) edge of CLK 468. In addition, although PWM 465 goes high (˜5V) right after the falling edge of CLK 468 (at about 978.0 μs), the ON cycle does not terminate until TON_MIN 460 goes high (at about 978.2 μs). Thus, the ON cycle is equal to or is greater than the minimum on-time.

FIG. 5 is an example application circuit for a dual-mode buck integrated circuit 520. The application circuit can convert a higher input voltage (V_{IN}) and deliver a lower output voltage to the load (V_{OUT}) while maintaining high efficiency at different load levels. As shown, the output pin (SW) of the dual-mode buck integrated circuit 520 is connected to an inductor 502, which is in turn connected to the load at Vout. Additionally, a capacitor 504 and a resistor divider (506 and 508) are connected in parallel with the load. The resistor divider is used to provide a feedback voltage to the dual-mode buck integrated circuit 520 via the FB pin. Moreover, a resistor 518 is connected to the feed forward pin (RFF), which allows a user to adjust the minimum-in time duration as described above.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

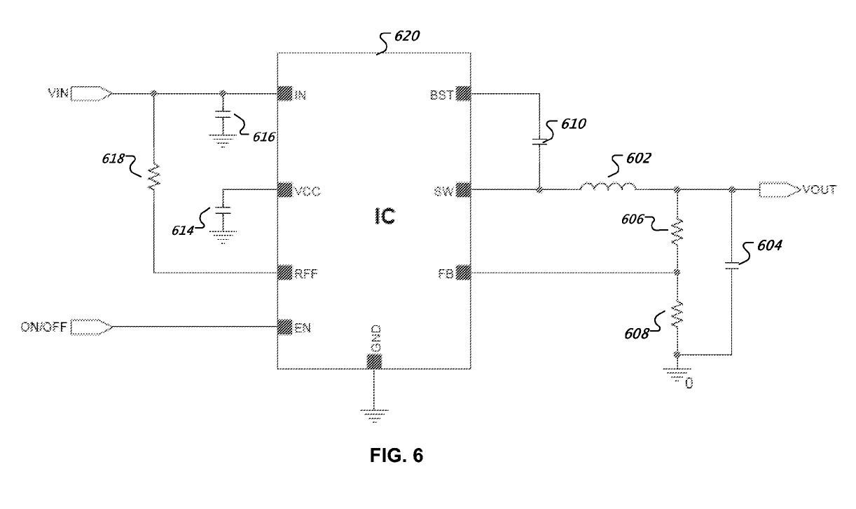

A number of embodiments have been described. Nevertheless, it will be understood that various modifications may be made without departing from the spirit and scope of the described embodiments. For example, some pins or functionality can be integrated into the dual-mode buck converter circuit. This reduces pin count and external components required for the buck converter. FIG. 6 is an example application circuit for a dual-mode buck integrated circuit 620. As shown, the converter circuit 620 only has 8 pins and the low-side transistor (LS MOS) of circuit 520 shown above has been integrated into the circuit 620; thus, the SDRV pin has been removed. In addition, the P_{Good} pin of circuit 520 has been removed to reduce pin count. Accordingly, other embodiments are within the scope of the following claims.

What is claimed is:

1. A switching regulator for DC-DC step-down voltage conversion, the switching regulator comprising:
a high-side transistor and a low-side transistor coupled in series;
a first circuitry configured to operate in a synchronous mode wherein the high-side transistor and the low-side transistor are used for voltage switching and to provide output to a load;
a second circuitry configured to operate in a non-synchronous mode wherein the low-side transistor remains off and further wherein the high-side transistor and one or more diodes are used for voltage switching and to provide output to the load; and
an automatic mode selector configured to output a control signal and automatically select between the synchronous mode of operation and the non-synchronous mode of operation based in part on a voltage between source and drain of the low-side transistor and a predetermined delay time.

2. The switching regulator of claim 1, wherein the mode selector automatically selects the non-synchronous mode of operation when the following conditions are met during the predetermined delay time:
the voltage between source and drain of the low-side transistor is greater than zero;
a pulse-width modulation (PWM) signal is logically low; and
a clock signal pulse is on a falling edge.

3. The switching regulator of claim 1, wherein the mode selector automatically selects the synchronous mode of operation when the following conditions are met during the predetermined delay time:
a voltage across the one or more diodes is less than zero;
a pulse-width modulation (PWM) signal is logically low; and
a clock signal pulse is on a falling edge.

4. The switching regulator of claim 1, wherein the predetermined delay time is a consecutive number of clock cycles.

5. The switching regulator of claim 1, wherein the non-synchronous mode of operation comprises a minimum on-time circuitry configured to keep the high-side transistor on for a period of time greater or equal to a predetermined minimum on-time duration.

6. The switching regulator of claim 1, wherein the minimum on-time circuitry is further configured such that the switching regulator operates in a pulse skipping mode wherein the switching frequency is reduced.

7. The switching regulator of claim 1, wherein the non-synchronous mode of operation comprises three operational states:
a first state during which the high-side transistor is on and the one or more diodes are off;
a second state during which the high-side transistor is off and the one or more diodes are on, wherein the switching regulator changes from the first state to the second state only if the PWM signal is logical high and an on-time of the high-side transistor is greater than or equal to a minimum on-time duration; and
a third state during which the high-side transistor is off and the one or more diodes are off.

8. The switching regulator of claim 5, wherein the minimum on-time duration is programmed by a user.

9. The switching regulator of claim 1, wherein the control signal is logically low when the switching regulator is operating in the synchronous mode and logically high when the switching regulator is operating in the non-synchronous mode.

10. The switching regulator of claim 1, wherein the one or more diodes comprise a body diode of the low-side transistor or a Schottky diode.

11. A method of operating a switching regulator for DC-DC step-down voltage conversion, the method comprising:
automatically determining whether the switching regulator should be operating in a synchronous mode wherein a high-side transistor and a low-side transistor are used for voltage switching or in a non-synchronous mode wherein a high-side transistor and one or more diodes are used for voltage switching, based in part on whether a control signal produced by an automatic mode selector is logically low or logically high;
operating the switching regulator in a synchronous mode if the control signal is logically low; and
operating the switching regulator in a non-synchronous mode if the control signal is logically high, wherein the low-side transistor remains off during the entire non-synchronous mode.

12. The method of claim 11, wherein the control signal is logically high when the following conditions are met for a predetermined delay time:
the voltage between source and drain of the low-side transistor is greater than zero;
a pulse-width modulation (PWM) signal is logically low; and
a clock signal pulse is on a falling edge.

13. The method of claim 11, wherein the control signal is logically low when the following conditions are met for a predetermined delay time:
a voltage across the one or more diodes is less than zero;
the pulse-width modulation (PWM) signal is logically low; and
the clock signal pulse is on a falling edge.

14. The method of claim 11, wherein during the non-synchronous mode of operation:
keeping the high-side transistor on for a period of time greater or equal to a predetermined minimum on-time duration.

15. The method of claim 14, further comprising:
operating the circuit in a pulse skipping mode wherein the switching frequency is reduced

16. The method of claim 11, wherein operating the switching regulator in a non-synchronous mode further comprises:
operating in a first state during which the high-side transistor is on and the one or more diodes are off; and
operating in a second state during which the high-side transistor is off and the one or more diodes are on, only if the PWM signal is logical high and an on-time of the high-side transistor is greater than or equal to a minimum on-time duration.

17. The method of claim 16, wherein the minimum on-time duration is programmed by a user.

18. The method of claim 11, wherein the one or more diodes comprise a body diode of the low-side transistor or a Schottky diode.

19. A switching regulator for DC-DC step-down voltage conversion, the switching regulator comprising:
a high-side transistor and a low-side transistor coupled in series;
a first circuitry configured to operate in a synchronous mode wherein the high-side transistor and the low-side transistor are used for voltage switching and to provide output to a load;
a second circuitry configured to operate in a non-synchronous mode wherein the low-side transistor remains off and further wherein the high-side transistor and one or more diodes are used for voltage switching and to provide output to the load; and
means for automatically selecting between the synchronous mode and the non-synchronous mode.

20. The switching regulator of claim 19, wherein the switching regulator further comprising:
means for increasing efficiency at low output current levels when the switching regulator is operating in the non-synchronous mode.
